(19) United States
(12) Patent Application Publication
(10) Pub. No.: US 2022/0153910 A1
(43) Pub. Date: May 19, 2022

(54) POLYURETHANE AND POLYISOCYANURATE HYBRID COATINGS

(71) Applicant: Covestro LLC, Pittsburgh, PA (US)

(72) Inventors: Liang Chen, Sewickley, PA (US); Alan D. Bushmire, Canonsburg, PA (US)

(21) Appl. No.: 16/951,049

(22) Filed: Nov. 18, 2020

(51) Int. Cl. C08G 18/22; C08G 18/24; C08G 18/73; C08G 18/48; C08G 18/42

(52) U.S. Cl. CPC C08G 18/225; C08G 18/246; C08G 18/4238; C08G 18/4825; C08G 18/73

(57) ABSTRACT

Provided is a polyurethane-polyisocyanurate hybrid composition comprising a mixture of an aliphatic polyisocyanate; a polyol having an acid number of ≤5 mg KOH/g; and a first catalyst, optionally, a second catalyst, wherein the mixture is reacted at an NCO/OH index of from 2.0 to 25. Also provided is a process for producing a polyurethane-polyisocyanurate hybrid composition, the process comprising forming a mixture of a) an aliphatic polyisocyanate, b) a polyol having an acid number of ≤5 mg KOH/g, and c) a first catalyst, optionally, d) a second catalyst, and reacting the mixture at an NCO/OH index of from 2.0 to 25. The polyol with a low acid value (≤5 mg KOH/g) included in the hybrid compositions helps ensure sufficient resin cure. The inventive polyurethane-polyisocyanurate hybrid compositions may find use in or as coatings and adhesives having improved hardness compared with polyisocyanurate coatings and higher reactivity that allows curing at lower temperatures.

### FIELD OF THE INVENTION

The present invention relates in general to polymers, and more specifically, to polyurethane-polyisocyanurate hybrid coating and adhesive compositions.

### BACKGROUND OF THE INVENTION

U.S. Pat. Pub. 2019/255788 discloses a new thermoset technology based on aliphatic polyisocyanates, which are unaffected by UV radiation and have excellent weathering resistance. The liquid resin has improved pot-life at room temperature and shows rapid curing at elevated temperatures. The novel composites are particularly suitable for outdoor applications. This technology has been applied to established composite manufacturing processes such as pultrusion.

Co-pending application U.S. Ser. No. 16/951,017 (attorney docket number 2020P30134US) filed on an even day herewith, discloses unique polyurethane-polyisocyanurate compositions that show good pot-life at room temperature, fast curing speed, and superior mechanical properties compared to polyurethane and polyisocyanurate. The NCO/OH index of those materials is preferably between 2.0 and 25 and the formulations have a pot life of over two hours. A single catalyst or dual catalysts may be used to catalyze the polyurethane and trimerization reactions. The inventors discovered that the trimerization catalyst can efficiently catalyze the urethane reaction at lower temperatures and subsequently catalyze trimerization at high temperatures.

To reduce problems, therefore, a need exists in the art for coatings and adhesives which take advantage of these new technologies.

### SUMMARY OF THE INVENTION

Accordingly, the present invention extends aliphatic polyurethane-polyisocyanurate hybrid compositions to coatings and adhesives. The polyurethane-polyisocyanurate hybrid compositions of the invention exhibit improved hardness and hardness compared with polyurethane coating; the hybrid coating compositions exhibit higher impact strength than polyisocyanurate coatings and higher reactivity that allows the use of lower cure temperatures. A polyol with a low acid value (≤5 mg KOH/g) included in the hybrid compositions helps ensure sufficient resin cure.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In a first aspect, the invention is directed to a polyurethane-polyisocyanurate hybrid composition comprising a mixture of an aliphatic polyisocyanate, a polyol having an acid number of ≤5 mg KOH/g, and a first catalyst, optionally, a second catalyst, wherein the mixture is reacted at an NCO/OH index of from 2.0 to 25.

In a second aspect, the invention is directed to a process for producing a polyurethane-polyisocyanurate hybrid composition, the process comprising forming a mixture of: a) an aliphatic polyisocyanate, b) a polyol having an acid number of ≤5 mg KOH/g, and c) a first catalyst, optionally, d) a second catalyst, and reacting the mixture at an NCO/OH index of from 2.0 to 25.

In a third aspect, the invention is directed to one of a coating or an adhesive comprising the polyurethane-polyisocyanurate hybrid composition according to one of the previous two paragraphs.

As used herein, the term “polymer” encompasses prepolymers, oligomers, and both homopolymers and copolymers; the prefix “poly” in this context refers to two or more. As used herein, the term “molecular weight”, when used in reference to a polymer, refers to the number average molecular weight, unless otherwise specified.

As used herein, the term “polyol” refers to compounds comprising at least two free hydroxy groups. Polyols include polymers comprising pendant and terminal hydroxy groups.

As used herein, the term “coating composition” refers to a mixture of chemical components that will cure and form a coating when applied to a substrate.

A “composite” or “composite composition” refers to a material made from one or more polymers, containing at least one other type of material (e.g., a fiber) which retains its identity while contributing desirable properties to the composite. A composite has different properties from those of the individual polymers/materials which make it up.

The terms “cured,” “cured composition” or “cured compound” refers to components and mixtures obtained from reactive curable original compound(s) or mixture(s) thereof which have undergone chemical and/or physical changes such that the original compound(s) or mixture(s) is(are) transformed into a solid, substantially non-flowing material. A typical curing process may involve crosslinking.

The term “curable” means that an original compound(s) or composition material(s) can be transformed into a solid, substantially non-flowing material by means of chemical reaction, crosslinking, radiation crosslinking, or the like. Thus, compositions of the invention are curable, but unless otherwise specified, the original compound(s) or composition material(s) is(are) not cured.

As indicated, the coating compositions of the present invention comprise a polyisocyanate. As used herein, the term “polyisocyanate” refers to compounds comprising at least two unreacted isocyanate groups, such as three or more unreacted isocyanate groups. The polyisocyanate may comprise diisocyanates such as linear aliphatic polyisocyanates, cycloaliphatic polyisocyanates and alkaryl polyisocyanates.

A “polyisocyanurate” resin is a resin having an isocyanurate ring structure obtained by trimerization of polyisocyanate. Polyisocyanurate resins are prepared by reaction of a polyisocyanate in the presence of a catalyst such as an isocyanuration (trimerization) catalyst. A “polyisocyanurate” means any molecule having a plurality of isocyanurate structural units, e.g., at least ten isocyanurate structural units. A molecule having a single isocyanurate structural unit is referred to as an “isocyanurate”.

A “prepolymer” means an oligomeric compound having functional groups which are involved in the final construction of polymers. In particular, it comprises, as is usual in polyurethane chemistry, compounds which contain at least one diisocyanate unit and at least one diol unit and are polymerizable further via the functional groups of these units.

A “composite polyisocyanurate material” means a composite material wherein the polymeric matrix material is a polymer containing polyisocyanurate. The polymeric matrix material may also comprise predominantly, or entirely, a polyisocyanurate. A polymeric matrix material composed of blends of polyisocyanurates and other plastics is likewise encompassed by the term “composite polyisocyanurate material”. The composite polyisocyanurate material may include allophanates and other side products.

Suitable aliphatic diisocyanates and prepolymers and polyisocyanates for use in the mixtures of the present invention are clear and colorless. Examples of such aliphatic polyisocyanates include those represented by the formula,

Q(NCO)n

wherein n is a number from 2-5, in some embodiments from 2-3, and Q is an aliphatic hydrocarbon group containing 2-12, in certain embodiments from 4-6, carbon atoms or a cycloaliphatic hydrocarbon group containing 4-6, in selected embodiments from 5-6, carbon atoms.

Examples of suitable aliphatic diisocyanates include 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and 1,4-diisocyanate, 1-isocyanato-2-isocyanato-methyl cyclopentane, 5-isocyanato-1-(isocyanatomethyl)-1,3,3-trimethylcyclohexane (IPDI), bis-(4-isocyanatocyclohexyl)methane, 1,3- and 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate (H₁₂MDI), pentane diisocyanate (PDI), and, isomers of any of these; or combinations of any of these. Mixtures of diisocyanates may also be used. Preferred diisocyanates include 1,6-hexamethylene diisocyanate, isophorone diisocyanate, and bis(4-isocyanatocyclohexyl)-methane because such are readily available and yield relatively low viscosity polyisocyanate formulations.

The aliphatic isocyanate can comprise at least one of a polyisocyanate comprising a biuret group, such as the biuret adduct of hexamethylene diisocyanate (HDI) available from Covestro AG as DESMODUR N-100, a polyisocyanate containing an isocyanurate group, such as that available from Covestro AG as DESMODUR N-3300, a polyisocyanate such as that available from Covestro AG as DESMODUR N-3600, which has a viscosity of 800-1400 mPa·s at 25° C., and a polyisocyanate containing at least one of an iminooxadiazine dione group, a urethane group, a uretdione group, a carbodiimide group, and an allophanate group.

Aliphatic isocyanate-terminated prepolymers may also be employed in the present invention. as those skilled in the art are aware, prepolymers may be prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). These compounds and their methods of preparation are well known to those skilled in the art. The use of any one specific active hydrogen compound is not critical; any such compound can be employed in the practice of the present invention. In certain embodiments, the polyisocyanate comprises blend based on a hexamethylene diisocyanate trimer and a dicyclohexylmethane-4,4-diisocyanate prepolymer.

The polyisocyanurates of the invention are obtainable by catalytic trimerization by the process of the invention. “Catalytic” as used herein means in the presence of a suitable trimerization catalyst. Catalysts for the formation of polyisocyanurates (i.e., trimerization catalysts) include metal-type catalysts, such as alkali metal carboxylates, metal alcoholates, metal phenolates and metal hydroxides, tertiary amines, quaternary ammonium salts, tertiary phosphines and phosphorus onium salts. These trimerization catalysts are often used in combination with other catalysts which promote the reaction of isocyanates with water and/or polyols to obtain a synergistic effect. Suitable catalysts include binary or ternary blends of tertiary amine, such as pentamethyldiethylenetriamine, dimethylcyclohexylamine or dimethylethanolamine and potassium organo-salts such as potassium octoate or potassium acetate.

Suitable trimerization catalysts for the processes of the invention are in principle all compounds which comprise at least one quaternary ammonium and/or metal salt and which are suitable for accelerating the trimerization of isocyanate groups to isocyanurate structures. According to the invention, the trimerization catalyst comprises at least one quaternary ammonium and/or metal salt as catalyst. In the context of the invention, a “quaternary ammonium” is understood to mean a compound of the formula NR₄⁺ where the “R” radical comprises organic radicals, especially alkyl or aryl radicals. Preferably, the quaternary ammonium is a compound of the formula NR₄⁺ where each of the R radicals is independently a linear or branched alkyl radical having 1 to 5 carbon atoms.

Suitable trimerization catalysts comprise, as metal salt, carboxylates and alkoxides of metals. In various embodiments of the invention, the trimerization catalysts include metal salts of aliphatic carboxylic acids having 1 to 20 and in some embodiments, 1 to 10 carbon atoms, for example metal salts of formic acid, acetic acid, propionic acid, butyric acid, valeric acid, caproic acid, enanthic acid, caprylic acid, pelargonic acid and capric acid. In selected embodiments, the catalysts include acetate salts.

In some embodiments of the process of the invention, the trimerization catalyst comprises, as metal component, an element selected from the group consisting of alkali metals, alkaline earth metals, tin, zirconium, zinc, iron and titanium.

In a various embodiments of the process of the invention, the trimerization catalyst comprises, as metal component, an alkali metal or alkaline earth metal. In certain embodiments, the metal components are sodium and potassium.

In an embodiment of the process of the invention, the trimerization catalyst comprises, as metal component, an alkaline alkali metal salt or alkaline earth metal salt which, as a saturated aqueous solution, has a pH of greater than 7, in certain embodiments greater than 8, and in selected embodiments, greater than 9 (measured with litmus paper) at 23° C. Particular preference is given to sodium salts and potassium salts.

In other embodiments, the metal salt is an alkali metal acetate or octoate or alkaline earth metal acetate or octoate, most preferably an alkali metal acetate. In various embodiments of the invention, tin octoate is preferred.

In certain embodiments, the trimerization catalyst also includes a polyether carrier solvent (40-95) wt %. Polyethers are selected from the group consisting of crown ethers, polyethylene glycols and polypropylene glycols. It has been found to be of particular relevance in the process of the invention to use a trimerization catalyst comprising, as polyether, a polyethylene glycol or a crown ether, more preferably 18-crown-6 or 15-crown-5. In some embodiments, the trimerization catalyst may comprise a polyethylene glycol having a number-average molecular weight of 100 to 1000 g/mol, in certain embodiments, of 106 to 1000 g/mol, in selected embodiments, 200 g/mol to 800 g/mol, especially 300 g/mol to 500 g/mol and most especially 350 g/mol to 450 g/mol. The term “polyethylene glycol” as used herein includes diethylene glycol.

Preferred trimerization catalysts for the process of the invention include potassium acetate or potassium octoate as alkali metal salt and polyethylene glycols as polyether, especially potassium acetate and polyethylene glycol having a number-average molecular weight of 400 g/mol.

Suitable polyols for inclusion in the polyurethane-polyisocyanurate hybrid compositions include those polyols having a number average molecular weight of from 200 to 8000 which is based on one of a polyether, a polyester, a polycarbonate, a polycarbonate ester, a polycaprolactone, a polybutadiene, the like, or a combination thereof. In various embodiments, the polyols have an acid number of ≤5 mg KOH/g, in certain embodiments, an acid number of ≤3 mg KOH/g, and in selected embodiments, the polyols have an acid number of ≤1.5 mg KOH/g.

Various embodiments include polyether polyols formed from the oxyalkylation of various polyols, including glycols such as ethylene glycol, 1,2- 1,3- or 1,4-butanediol, 1,6-hexanediol, and the like, or higher polyols, such as trimethylol propane, pentaerythritol and the like. One useful oxyalkylation method is by reacting a polyol with an alkylene oxide, e.g., ethylene oxide or propylene oxide in the presence of a basic catalyst or a coordination catalyst such as a double-metal cyanide (DMC).

Suitable polyester polyols can be prepared by the polyesterification of organic polycarboxylic acids, anhydrides thereof, or esters thereof with organic polyols. Preferably, the polycarboxylic acids and polyols are aliphatic or aromatic dibasic acids and diols.

The diols which may be employed in making the polyester include alkylene glycols, such as ethylene glycol, 1,2- 1,3- or 1,4-butanediol, neopentyl glycol and other glycols such as cyclohexane dimethanol, caprolactone diol (for example, the reaction product of caprolactone and ethylene glycol), polyether glycols, e.g., poly(oxytetramethylene) glycol and the like. However, other diols of various types and, as indicated, polyols of higher functionality may also be utilized in various embodiments of the invention. Such higher polyols can include, for example, trimethylol propane, trimethylol ethane, pentaerythritol, and the like, as well as higher molecular weight polyols such as those produced by oxyalkylating low molecular weight polyols.

The acid component of the polyester consists primarily of monomeric carboxylic acids, or anhydrides thereof, or esters thereof having 2 to 18 carbon atoms per molecule. Among the acids which are useful are phthalic acid, isophthalic acid, terephthalic acid, tetrahydrophthalic acid, hexahydrophthalic acid, adipic acid, succinic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid (propane-1,2,3-tricarboxylic acid).

In addition to polyester polyols formed from polybasic acids and polyols, polycaprolactone-type polyesters can also be employed. These products are formed from the reaction of a cyclic lactone such as 8-caprolactone with a polyol containing primary hydroxyls such as those mentioned above. Such products are described, e.g., in U.S. Pat. No. 3,169,949.

Suitable hydroxy-functional polycarbonate polyols may be those prepared by reacting monomeric diols (such as 1,4-butanediol, 1,6-hexanediol, di-, tri- or tetraethylene glycol, di-, tri- or tetrapropylene glycol, 3-methyl-1,5-pentanediol, 4,4′-dimethylolcyclohexane and mixtures thereof) with diaryl carbonates (such as diphenyl carbonate, dialkyl carbonates (such as dimethyl carbonate and diethyl carbonate), alkylene carbonates (such as ethylene carbonate or propylene carbonate), or phosgene. Optionally, a minor amount of higher functional, monomeric polyols, such as trimethylolpropane, glycerol or pentaerythritol, may be used.

In various embodiments, low molecular weight diols, triols, and higher alcohols may be included. In many embodiments, they are monomeric and have hydroxyl values of 375 to 1810. Such materials can include aliphatic polyols, particularly alkylene polyols containing from 2 to 18 carbon atoms. Examples include ethylene glycol, 1,4-butanediol, 1,6-hexanediol, and cycloaliphatic polyols such as cyclohexane dimethanol. Examples of triols and higher alcohols include trimethylol propane and pentaerythritol. Also useful are polyols containing ether linkages such as diethylene glycol and triethylene glycol.

The second, optional, catalyst can comprise any urethane catalyst such as, for example, an amine catalyst (e.g., 1,8-diazabicyclo[5.4.0]undec-7-ene (DBU), 1,4-diazabicyclo[2.2.2]octane (DABCO) or triethanolamine), a Lewis acid compound (e.g., dibutyltin dilaurate), lead octoate, tin octoate, a titanium complex, a zirconium complex, a cadmium compound, a bismuth compound (e.g., bismuth neodecanoate), and an iron compound. The second catalyst, if present in the reaction mixture, may be in an amount of no more than 3.0% by weight based on the total solids contents of the composition.

As mentioned herein, the polyurethane-polyisocyanurate hybrid mixture is reacted in various embodiments, at an NCO/OH index of from 2.0 to 25, in certain embodiments the mixture is reacted at an NCO/OH index of from 2.0 to 10, and in selected embodiments the mixture is reacted at an NCO/OH index of from 2.0 to 7.5. “NCO index” as used herein means the molar ratio of all NCO groups present in the reaction mixture to all NCO-reactive groups present in the mixture.

The coatings and adhesives of embodiments of the invention may further include any of a variety of additives such as defoamers, devolatilizers, thickeners, flow control additives, colorants (including pigments and dyes), surfactants, dispersants, and neutralizers as is known to those skilled in the art. The coatings and adhesives of the present invention may be admixed and combined with the conventional paint-technology binders, auxiliaries and additives, selected from the group of pigments, dyes, matting agents, flow control additives, wetting additives, slip additives, pigments, including metallic effect pigments, fillers, nanoparticles, light stabilizing particles, anti-yellowing additives, thickeners, and additives for reducing the surface tension. The coatings and adhesives according to the invention can be applied to a substrate by conventional techniques, such as, spraying, rolling, flooding, printing, knife-coating, pouring, brushing and dipping.

### Examples

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated. The following materials were used in preparation of the Examples:

| | |
|---|---|
| ISOCYANATE | a solvent-free polyfunctional aliphatic polyisocyanate |
| A | resin based on hexamethylene diisocyanate (HDI); low- |
| | viscosity HDI trimer; NCO content 23.0% ± 0.5; |
| | viscosity 1,200 ± 300 mPa · s @ 23° C.; |
| POLYOL A | a polypropylene oxide-based diol; hydroxyl number 495- |
| | 535 mg KOH/g; specific gravity at 25° C. of 1.02; |
| POLYOL B | a polyester polyol with an average Mₙ ~970, and an |
| | acid value of 1.8 mg KOH/g; |
| POLYOL C | a polyester polyol with an average Mₙ ~1540, and an |
| | acid value of 16 mg KOH/g; |
| CATALYST A | potassium acetate (5 wt. % solid) in polyethylene glycol |
| | (PEG-400); |
| CATALYST B | potassium acetate 33 wt. % in diethylene glycol (DEG) |
| | (DABCO K2097); |
| CATALYST C | potassium acetate (10 wt. % solid) in PEG-400; |
| CATALYST D | dibutyltin carboxylate; |
| ADDITIVE A | a surface additive on polyacrylate-basis for solvent-borne |
| | coating systems and printing inks, commercially |
| | available from BYK Chemie as BYK-358N; and |
| SOLVENT A | n-butyl acetate. |

Resin formulations were prepared as follows: polyisocyanate resins were mixed, optionally with ADDITIVE A, using a speed mixer (FLACKTEK INC.) at 2000 rpm for one-minute. Then, the mixture was mixed with the indicated catalyst for one-minute at 2000 rpm. The formulation was drawn down as clear ˜50 μm films on a steel panel substrate (ACT 4 inch×12 inch (10.2 cm×30.5 cm) B952 P90 unpolished ECOAT) and cured at set temperatures (150° C. and 180° C. for 30 minutes) and tested using standard methods (MEK double rub, impact, and hardness).

Cured resin plaques with uniform thickness (e.g. 1 mm) were also prepared for physical property characterization. The resin formulations were prepared as above mentioned followed by degassing on a speed mixer under vacuum (50 mbar) for three minutes. The formulation was poured onto a glass plate with 3 mm thick TEFLON spacers. The glass plate and liquid mixture were covered with a second glass plate and clamped using binder clips to prevent sample leakage during the thermal curing process. The samples were cured in an oven at 150° C. or 180° C. for 30 minutes. The tensile tests were measured according to ASTM D638 at 23° C. The flexural tests were measured according to ASTM D790 at 25° C. The impact tests were measured according to ASTM D 2794.

A PerkinElmer Differential Scanning calorimetry (DSC) instrument (DSC 800) with a liquid nitrogen cooling accessory was used to evaluate the samples. The cooling block temperature was set at −120° C. Ultra-high purity nitrogen was used as the furnace purge gas. The samples were evaluated over the range of −20° C. to 250° C. using 10° C./min ramps. The instrument furnaces were cooled to −20° C. before the sample pan was inserted. Each sample was subjected to a one-minute isothermal hold at −20° C. Next, each sample was heated to 250° C. After an isothermal hold of one minute, samples were cooled to −20° C. After an isothermal hold of one minute at −20° C., samples were reheated to 250° C. to determine the glass transition temperature and to look for additional curing.

A TA Instruments ARES-G2 with a torsion rectangular fixture was used for DMA evaluation of the samples. Samples were evaluated from −100° C. to 170° C. using a 2° C./min ramp. A 0.04% strain was applied at a frequency of 1 Hz.

TABLE I

| | I-A | I-B | I-C | I-D |
|---|---|---|---|---|
| ISOCYANATE A | 63.64 | 78.4 | 88.2 | 98 |
| POLYOL A | 36.16 | 19.6 | 9.8 | 0 |
| CATALYST C | 0 | 2.0 | 2.0 | 2.0 |
| CATALYST D | 0.1 | 0.05 | 0.05 | 0 |
| NCO/OH index | 1.05 | 2.27 | 4.85 | 56.57 |
| % elongation at break | 160.6 | 6.1 | 7.3 | 2.3 |
| Modulus (MPa) | — | 1866 | 1894 | 1938 |
| Tensile Strength (MPa) | 16.6 | 49.3 | 51.4 | 37.1 |
| Flexural Modulus | — | 2.30 | 2.25 | — |
| Flexural strength | — | 91.9 | 97.2 | — |
| T_{g} (° C.) DMA | 31 | 69 | 97 | 113 |
| T_{g} (° C.) DSC | 27 | 51 | 87 | 114 |

A second set of experiments, summarized in Table I, showed the change of mechanical properties from pure polyurethane to polyisocyanates. Both polyurethane catalyst and trimerization catalyst were used in the formulation to promote the reactions at elevated temperatures. The samples were cured at 150° C. for 30 min. The data showed that the polyisocyanates were completely reacted into polyurethane and polyisocyanurate. The percent elongation at break, modulus and tensile strength were determined according to ASTM D 638. The flexural modulus and flexural strength were determined according to ASTM D790. The glass transition temperature (T_{g}) was determined by DMA and DSC. Microindention hardness was determined using a FISCHERSCOPE HM2000 nanoindentation system (Helmut Fischer GmbH, Institut für Elektronik und Messtechnik, Germany), according to DIN EN ISO 14577 (ASTM E2546).

The initial polyester polyol experiment revealed that residual acid in the polyol affects trimerization. For example, POLYOL C inhibits the trimerization reaction due to its high acid value. Therefore, having a low acid value (<5 mg KOH/g) in the polyol is important in enabling the benefit of polyisocyanurate. POLYOL B was used to generate the data in Table II.

TABLE II

| | II-1 | II-2 | II-3 | II-4 | II-5 | II-6A | II-6B |
|---|---|---|---|---|---|---|---|
| POLYOL B | 59.23 | 45.87 | 58.73 | 45.49 | 26.58 | 0 | 0 |
| ADDITIVE A | 0.25 | 0.25 | 0.25 | 0.25 | 0.25 | 0.25 | 0.25 |
| CATALYST D | 0.20 | 0.20 | | | | | |
| CATALYST B | | | 0.60 | 0.60 | 0.60 | | |
| CATALYST A | | | | | | 4.0 | 4.0 |
| SOLVENT A | 18.03 | 20.71 | 18.13 | 20.78 | 24.56 | | |
| ISOCYANATE A | 22.47 | 33.15 | 22.28 | 32.87 | 48.01 | 96.00 | 96.00 |
| Total | 100.00 | 100.00 | 100.00 | 100.00 | 100.00 | 100 | 100 |
| NCO/OH index | 1.05 | 2.50 | 1.05 | 2.50 | 5.00 | 27.7 | 27.7 |

| | | | |
|---|---|---|---|
| Cure for 30 min | 150° C. | 150° C. | 180° C. |

Microindentation hardness results

| | | | | | | | |
|---|---|---|---|---|---|---|---|
| Same Day (N/mm²) | 1.43 | 5.34 | 1.65 | 33.54 | 99.97 | 96.93 | 96.05 |
| 24 hour (N/mm²) | 1.45 | 6.65 | 1.62 | 35.99 | 100.93 | 98.25 | 97.91 |

Impact

| | | | | | | | |
|---|---|---|---|---|---|---|---|
| Direct (inch-lbs.) | >160 | >160 | >160 | >160 | >160 | 80-100* | 120-140** |
| Indirect (inch-lbs.) | >160 | >160 | >160 | >160 | >160 | 80-100* | >160** |

MEK resistance

| | | | | | | | |
|---|---|---|---|---|---|---|---|
| 10 rub evaluation | Passed | Passed | Passed | Passed | Passed | Passed | Passed |
| Cross-hatch adhesion | 5B | 5B | 5B | 5B | 5B | 5B | 5B |

*Example II-6A—delamination on both sides of panel
**Example II-6B—Indirect impact had no visible defects, direct impact had slight cracking but no delamination

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. A polyurethane-polyisocyanurate hybrid composition comprising a mixture of an aliphatic polyisocyanate, a polyol having an acid number of ≤5 mg KOH/g, and a first catalyst, optionally, a second catalyst, wherein the mixture is reacted at an NCO/OH index of from 2.0 to 25.

Clause 2. The polyurethane-polyisocyanurate hybrid composition according to Clause 1, wherein the aliphatic polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and 1,4-diisocyanate, 1-isocyanato-2-isocyanato-methyl cyclopentane, 5-isocyanato-1-(isocyanatomethyl)-1,3,3-trimethylcyclohexane (IPDI), bis-(4-isocyanatocyclohexyl)methane, 1,3- and 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate (H₁₂MDI), pentane diisocyanate (PDI), trimers of any of these, prepolymers of any of these, isomers of any of these, allophanates of any of these, and combinations of any of these.

Clause 3. The polyurethane-polyisocyanurate hybrid composition according to one of Clauses 1 and 2, wherein the first catalyst is a trimerization catalyst.

Clause 4. The polyurethane-polyisocyanurate hybrid composition according to Clause 3, wherein the trimerization catalyst is an alkali metal salt or an alkaline earth metal salt.

Clause 5. The polyurethane-polyisocyanurate hybrid composition according to Clause 4, wherein the salt is selected from the group consisting of alkoxides, amides, phenoxides, carbonates, hydrogen carbonates, hydroxides, cyanides, isocyanides, thiocyanides, sulfides, sulfites, sulfinates, phosphites, phosphinates, phosphonates, phosphates, and fluorides.

Clause 6. The polyurethane-polyisocyanurate hybrid composition according to one of Clauses 4 and 5, wherein the metal is selected from the group consisting of manganese, iron, cobalt, nickel, copper, zinc, zirconium, cerium, tin, titanium, hafnium, lead, lithium, sodium, potassium, magnesium, calcium, strontium, and barium.

Clause 7. The polyurethane-polyisocyanurate hybrid composition according to any one of Clauses 1 to 6, wherein the polyol has an acid number of ≤3 mg KOH/g.

Clause 8. The polyurethane-polyisocyanurate hybrid composition according to any one of Clauses 1 to 6, wherein the polyol has an acid number of ≤1.5 mg KOH/g.

Clause 9. The polyurethane-polyisocyanurate hybrid composition according to any one of Clauses 1 to 8, wherein the mixture is reacted at an NCO/OH index of from 2.0 to 10.

Clause 10. The polyurethane-polyisocyanurate hybrid composition according to any one of Clauses 1 to 8, wherein the mixture is reacted at an NCO/OH index of from 2.0 to 7.5.

Clause 11. One of a coating and an adhesive comprising the polyurethane-polyisocyanurate hybrid composition according to any one of Clauses 1 to 10.

Clause 12. A process for producing a polyurethane-polyisocyanurate hybrid composition, the process comprising forming a mixture of: a) an aliphatic polyisocyanate, b) a polyol having an acid number of ≤5 mg KOH/g, and c) a first catalyst, optionally, d) a second catalyst, and reacting the mixture at an NCO/OH index of from 2.0 to 25.

Clause 13. The process according to Clause 12, wherein the aliphatic polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and 1,4-diisocyanate, 1-isocyanato-2-isocyanato-methyl cyclopentane, 5-isocyanato-1-(isocyanatomethyl)-1,3,3-trimethylcyclohexane (IPDI), bis-(4-isocyanatocyclohexyl)methane, 1,3- and 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate (H₁₂MDI), pentane diisocyanate (PDI), trimers of any of these, prepolymers of any of these, isomers of any of these, allophanates of any of these, and combinations of any of these.

Clause 14. The process according to one of Clauses 12 and 13, wherein the first catalyst is a trimerization catalyst.

Clause 15. The process according to Clause 14, wherein the trimerization catalyst is an alkali metal salt or an alkaline earth metal salt.

Clause 16. The process according to Clause 15, wherein the salt is selected from the group consisting of alkoxides, amides, phenoxides, carbonates, hydrogen carbonates, hydroxides, cyanides, isocyanides, thiocyanides, sulfides, sulfites, sulfinates, phosphites, phosphinates, phosphonates, phosphates, and fluorides.

Clause 17. The process according to one of Clauses 15 and 16, wherein the metal is selected from the group consisting of manganese, iron, cobalt, nickel, copper, zinc, zirconium, cerium, tin, titanium, hafnium, lead, lithium, sodium, potassium, magnesium, calcium, strontium, and barium.

Clause 18. The process according to any one of Clauses 12 to 17, wherein the polyol has an acid number of ≤3 mg KOH/g.

Clause 19. The process according to any one of Clauses 12 to 17, wherein the polyol has an acid number of ≤1.5 mg KOH/g.

Clause 20. The process according to any one of Clauses 12 to 19, wherein the mixture is reacted at an NCO/OH index of from 2.0 to 10.

Clause 21. The process according to any one of Clauses 12 to 19, wherein the mixture is reacted at an NCO/OH index of from 2.0 to 7.5.

Clause 22. One of a coating and an adhesive comprising the polyurethane-polyisocyanurate hybrid composition produced according to any one of Clauses 12 to 21.

What is claimed is:

1. A polyurethane-polyisocyanurate hybrid composition comprising a mixture of:
an aliphatic polyisocyanate;
a polyol having an acid number of ≤5 mg KOH/g; and
a first catalyst,
optionally, a second catalyst,
wherein the mixture is reacted at an NCO/OH index of from 2.0 to 25.

2. The polyurethane-polyisocyanurate hybrid composition according to claim 1, wherein the aliphatic polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanato-methyl cyclopentane, 5-isocyanato-1-(isocyanatomethyl)-1,3,3-trimethylcyclohexane, bis-(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate, pentane diisocyanate, trimers of any of these, prepolymers of any of these, isomers of any of these, allophanates of any of these, and combinations of any of these.

3. The polyurethane-polyisocyanurate hybrid composition according to claim 1, wherein the first catalyst is a trimerization catalyst.

4. The polyurethane-polyisocyanurate hybrid composition according to claim 3, wherein the trimerization catalyst is an alkali metal salt or an alkaline earth metal salt.

5. The polyurethane-polyisocyanurate hybrid composition according to claim 4, wherein the salt is selected from the group consisting of alkoxides, amides, phenoxides, carbonates, hydrogen carbonates, hydroxides, cyanides, isocyanides, thiocyanides, sulfides, sulfites, sulfinates, phosphites, phosphinates, phosphonates, phosphates, and fluorides.

6. The polyurethane-polyisocyanurate hybrid composition according to claim 5, wherein the metal is selected from the group consisting of manganese, iron, cobalt, nickel, copper, zinc, zirconium, cerium, tin, titanium, hafnium, lead, lithium, sodium, potassium, magnesium, calcium, strontium, and barium.

7. The polyurethane-polyisocyanurate hybrid composition according to claim 1, wherein the polyol has an acid number of ≤3 mg KOH/g.

8. The polyurethane-polyisocyanurate hybrid composition according to claim 1, wherein the polyol has an acid number of ≤1.5 mg KOH/g.

9. The polyurethane-polyisocyanurate hybrid composition according to claim 1, wherein mixture is reacted at an NCO/OH index of from 2.0 to 10.

10. The polyurethane-polyisocyanurate hybrid composition according to claim 1, wherein mixture is reacted at an NCO/OH index of from 2.0 to 7.5.

11. A process for producing a polyurethane-polyisocyanurate hybrid composition, the process comprising:
forming a mixture of:
a) an aliphatic polyisocyanate;
b) a polyol having an acid number of ≤5 mg KOH/g; and
c) a first catalyst,
optionally,
d) a second catalyst,
and
reacting the mixture at an NCO/OH index of from 2.0 to 25.

12. The process according to claim 11, wherein the aliphatic polyisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanato-methyl cyclopentane, 5-isocyanato-1-(isocyanatomethyl)-1,3,3-trimethylcyclohexane, bis-(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, 1-isocyanato-1-methyl-4(3)-isocyanato-methyl cyclohexane, dicyclohexylmethane-4,4-diisocyanate, pentane diisocyanate, trimers of any of these, prepolymers of any of these, isomers of any of these, allophanates of any of these, and combinations of any of these.

13. The process according to claim 11, wherein the first catalyst is a trimerization catalyst.

14. The process according to claim 13, wherein the trimerization catalyst is an alkali metal salt or an alkaline earth metal salt.

15. The process according to claim 14, wherein the salt is selected from the group consisting of alkoxides, amides, phenoxides, carbonates, hydrogen carbonates, hydroxides, cyanides, isocyanides, thiocyanides, sulfides, sulfites, sulfinates, phosphites, phosphinates, phosphonates, phosphates, and fluorides.

16. The process according to claim 14, wherein the metal is selected from the group consisting of manganese, iron, cobalt, nickel, copper, zinc, zirconium, cerium, tin, titanium, hafnium, lead, lithium, sodium, potassium, magnesium, calcium, strontium, and barium.

17. The process according to claim 11, wherein the polyol has an acid number of ≤3 mg KOH/g.

18. The process according to claim 11, wherein the polyol has an acid number of ≤1.5 mg KOH/g.

19. The process according to claim 11, wherein the mixture is reacted at an NCO/OH index of from 2.0 to 10.

20. The process according to claim 12, wherein the mixture is reacted at an NCO/OH index of from 2.0 to 7.5.
